(19) United States
(12) Patent Application Publication
(10) Pub. No.: US 2025/0320883 A1
(43) Pub. Date: Oct. 16, 2025

(54) Method and System for Controlling a Total Movement of a Distribution Boom, and Method for Distributing Construction Material and/or Thick Matter by Means of a Construction Material and/or Thick Matter Pump Device Having a Distribution Boom

(71) Applicant: Putzmeister Engineering GmbH, Aichtal (DE)

(72) Inventors: Wilhelm F. HOFMANN, Niederdorfelden (DE); Francisco Martin BRUGUE, Darmstadt (DE); Juergen BRAUN, Offenbach (DE)

(21) Appl. No.: 18/868,264

(22) PCT Filed: Apr. 19, 2023
(86) PCT No.: PCT/EP2023/060176

§ 371 Date: Nov. 22, 2024

(30) Foreign Application Priority Data
May 24, 2022 (DE) 10 2022 205 169.6

(51) Int. Cl. F15B 20/00; E04G 21/04; F15B 13/044; F15B 19/00

(52) U.S. Cl. CPC F15B 20/004; E04G 21/0463; F15B 13/044; F15B 19/00

(57) ABSTRACT

A method controls a total movement of a distribution boom, wherein the distribution boom has a number of boom arms, wherein the boom arms can be moved by means of a number of hydraulic drives. The method includes the following steps: a) monitoring whether, for the total movement, at least one drive of the drives is insufficiently supplied by a hydraulic pumping device for supplying the drives with hydraulic liquid; and b) in the event of insufficient supply, controlling a non-proportional reduction of the supply of the drives with hydraulic liquid for the non-proportional reduction of movement speeds of the drives and/or an increase of the supply of the drives with hydraulic liquid by the pumping device.

### BACKGROUND AND SUMMARY

The invention relates to a method and a system, in particular each, for controlling a total movement of a distribution boom and a method for distributing construction material and/or thick matter by means of a construction material and/or thick matter pump device having a distribution boom having such a method for controlling the total movement of the distribution boom.

The invention addresses the problem of providing a method and a system, in particular each, for controlling a total movement of a distribution boom, which, in particular in each case, has improved properties, and a method for distributing construction material and/or thick matter by means of a construction material and/or thick matter pump device having a distribution boom having such a method for controlling the total movement of the distribution boom.

The invention solves this problem by providing a method and a system described in the independent claims. Advantageous developments and embodiments of the invention are described in the dependent claims.

The method according to the invention is for controlling a total movement of a distribution boom. The distribution boom has a plurality of boom arms. The boom arms can be moved or are moved by means of a plurality of hydraulic drives. The method comprises the following steps: a) monitoring whether, for the or to perform the total movement, at least one drive, in particular a plurality of drives, of the drives is, in particular are, in particular currently, insufficiently supplied by a hydraulic or by means of a hydraulic pump device for supplying the drives with hydraulic liquid; b) in the event of or in the case of the, in particular current, insufficient supply, controlling a non-proportional reduction of the supply, in particular at least one value of the supply, of the drives with hydraulic liquid for the non-proportional reduction of, in particular respective, movement speeds, in particular at least one value of the movement speeds, of the drives and/or an increase of the supply, in particular a value of the supply, of the drives with hydraulic liquid by the pump device.

This enables the supply to one of the drives to be reduced and the supply to another of the drives to be reduced to a lesser extent or not at all. Thus, this enables a, in particular linear, proportional reduction of the supply to the drives and thus a proportional or uniform reduction of each movement speed or an adjustment of all movement speeds of the drives to be avoided. Additionally or alternatively, in particular as a result, this makes it possible that the pump device, in particular a size of the pump device, does not need to be oversized and/or that the available supply of hydraulic liquid can be sufficient, in particular always. This therefore enables low costs. Additionally or alternatively, increasing the supply of hydraulic liquid to the drives by the pump device makes it possible to reduce or even avoid “starvation” of individual boom arms. This therefore makes it possible to reduce or even avoid path or position deviations or incorrect positions and/or, in particular, to ensure that a total movement, in particular an actual total movement, of the distribution boom corresponds to, in particular is equal to, the total movement, in particular a predetermined total movement, of the distribution boom. This therefore makes it possible to increase safety, particularly in the event of critical collision problems and/or, in particular, to reduce or even avoid a potential hazard. This makes it possible to optimize the total movement in the event of an insufficient supply and/or to compensate for or even end the insufficient supply.

In particular, the method, the control, the monitoring, the reduction and/or the increase can be automatic and/or electrical.

The control can be an open-loop control and/or a closed-loop control, in particular.

The total movement can have simultaneous or concurrent or joint movements of a plurality of boom arms of the boom arms or a plurality of drives of the drives, in particular.

The distribution boom can be a construction material and/or thick matter distribution boom. Additionally or alternatively, the distribution boom can be a construction material and/or thick matter pump device. In particular, the construction material and/or thick matter pump device can be designed for conveying construction material and/or thick matter. In particular, construction material may denote mortar, cement, screed, concrete and/or plaster. Further additionally or alternatively, thick material may denote sludge. In particular, the distribution boom may be a concrete distribution boom. Further additionally or alternatively, the distribution boom may be adjustable.

The boom arms can be adjustable or movable, in particular by means of a plurality of joints and/or a slewing gear. In particular, a plurality of the drives can be articulated drives and/or one of the drives can be a slewing gear drive. Additionally or alternatively, the movement speeds can be axis speeds.

The term “boom element” can be used synonymously with the term “boom arm”.

The term “configured” can be used synonymously with the term “designed”.

The term “comprises” or “has” can be used synonymously with the term “contains”.

The term “determine” can be used synonymously with the term “monitor”.

The term “inadequate supply” can be used synonymously with the term “insufficient supply”.

The term “present” or “momentary” can be used synonymously with the term “current”.

The term “lower” can be used synonymously with the term “reduce”.

The hydraulic liquid may contain oil, in particular.

The reduction and/or the increase can be in at least one, in particular at least two, in particular at least three, stages and/or can be stepless or variable and/or dependent on or in a ratio or relation to, in particular a measure of, the insufficient supply.

The control can be, in particular in terms of time, firstly an increase and, in the event that the increase is not sufficient, the control can be, in particular in terms of time, secondly the reduction.

If there is no insufficient supply, it is not necessary or not possible to carry out the control or step b).

The control can, in particular the reduction and/or the increase can, be carried out permanently over time, in particular until the insufficient supply is terminated or ends.

Step b) can be carried out after step a). In addition or alternatively, the method, in particular step a) and/or step b), can be repeated or carried out again, in particular a plurality of times and/or regularly.

In a development of the invention, the pump device is, in particular only, one, in particular single, common pump device for the, in particular common, supply of hydraulic liquid to the drives. In particular, the pump device has only a single hydraulic pump. This enables, in particular on the one hand, favorable costs and/or, in particular on the other hand, that the case of an insufficient supply of the at least one drive can have an effect on all other drives. In particular, the common pump device can be designed to supply hydraulic liquid to at least portions of a common hydraulic circuit for supplying the drives with hydraulic liquid. Additionally or alternatively, the pump device may or may not have a plurality of hydraulic pumps for a single or individual supply of hydraulic liquid to the drives.

In a development of the invention, at least one of the drives has an electrically controllable hydraulic valve or at least one of the drives is assigned an electrically controllable hydraulic valve. Controlling the reduction comprises controlling the hydraulic valve. This enables electrohydraulic, in particular and thus easy and/or simple and/or inexpensive, control.

In a development of the invention, at least one of the drives is a hydraulic cylinder and/or a hydraulic motor. The hydraulic cylinder enables the movement of the joint and/or the hydraulic motor enables the movement of the slewing gear. In particular, the term “hydraulic linear motor” can be used synonymously for the term “hydraulic cylinder”. Additionally or alternatively, the term “hydromotor” can be used synonymously for the term “hydraulic motor”.

In a development of the invention, the monitoring or step a) comprises: determining, in particular capturing, in particular and evaluating, data, in particular values of the data, of at least one sensor device. In particular, ascertaining the insufficient supply as a function of the, in particular determined, in particular captured, in particular evaluated data. This enables an immediate or direct ascertainment of the insufficient supply. In particular, the determination, capture, evaluation and/or ascertainment can be automatic. Additionally or alternatively, the term “define” can be used synonymously with the term “ascertain”. Further additionally or alternatively, the term “measure” may be used synonymously with the term “capture”. Further additionally or alternatively, the insufficient supply may be determined if the data or a quantity based on the data, in particular a physical quantity, reaches or exceeds an upper limit value and/or reaches or drops below a lower limit value, in particular wherein the lower limit value may be smaller than the upper limit value. Further additionally or alternatively, the data or the variable based thereon may be current. Further additionally or alternatively, the sensor device may be electrical.

In one embodiment of the invention, the data comprise at least one control variable of at least one of the drives and/or at least one status variable of the pump device, at least one of the drives and/or at least one of the boom arms, in particular are such a variable. In particular, the data comprise a control signal, in particular an electrical control current, a hydraulic liquid volume flow, a hydraulic liquid pressure, in particular a boom pressure, a cylinder pressure and/or a motor pressure, and/or a trailing distance, in particular are such a variable. Such a variable enables a particularly simple and/or good ascertainment of the insufficient supply. In particular, the control signal can be pneumatic or by means of air and/or optical or by means of light. Additionally or alternatively, the control signal, in particular the electrical control current, can be a control signal of the hydraulic valve. Further additionally or alternatively, the evaluation may comprise evaluating a shape and/or a change of the data, in particular of the control signal, in particular of the control of the hydraulic valve, for example viewing a slope of the data, in particular of the control signal, may be a measure of the, in particular current, insufficient supply. Further additionally or alternatively, the control signal may be an output signal. In particular, the output signal (control flow or actuation flow) can be monitored and an individual hydraulic liquid quantity and a total hydraulic liquid quantity can be measured/calculated via at least one individual valve size on a boom block of the distribution boom. In particular, this can have the advantage that position control and/or damping can also be captured. Further additionally or alternatively, a flow rate at the boom block and/or the pump device can be captured or measured. Further additionally or alternatively, the term “volume flow rate” or “quantity” can be used synonymously for the term “volume flow”. Further additionally or alternatively, the insufficient supply can be determined if the boom pressure falls below the lower limit value or a control/setting value. Further additionally or alternatively, the cylinder pressure can be a cylinder pressure of the hydraulic cylinder. Further additionally or alternatively, the motor pressure can be a motor pressure of the hydraulic motor. Further additionally or alternatively, the trailing distance may be a measure of a position deviation during the movement and/or a difference between a target position value and an actual position value.

In a development of the invention, the monitoring or step a) comprises: determining, in particular calculating, supply requirements, in particular respective and/or current supply requirements, in particular values of the supply requirements, of the drives, in particular with hydraulic liquid, for the total movement. Additionally or alternatively determining, in particular calculating, a, in particular current, supply availability, in particular a value of the supply availability and/or with hydraulic liquid, by the pump device. In particular, determining the insufficient supply if the supply requirements, in particular in total, are greater than the supply availability. This allows the insufficient supply to be determined indirectly. In particular, the determination, calculation and/or ascertainment can be automatic.

In one embodiment of the invention, the determination of the supply requirements comprises a determination as a function of a, in particular current, specification, in particular at least one value of the specification and/or a user specification, for the total movement. The method makes it possible to reduce or even avoid path or position deviations or incorrect positions, so that these do not need to be corrected, in particular by a corresponding reaction of the user. This enables simple and/or good ergonomics. In particular, the specification can be a target specification and/or can have a, in particular vectorial, movement variable, in particular a target movement variable, in particular can be, and/or determine a movement, in particular a target movement and/or a movement speed, in particular a target movement speed, and/or a movement direction, in particular a target movement direction, of a boom tip of the distribution boom. Additionally or alternatively, the term “operator” can be used synonymously with the term “user”. Further additionally or alternatively, the user specification can be specified by means of an input device, in particular a joystick. Further additionally or alternatively, the method may comprise the step of: determining, in particular automatically determining and/or capturing, the specification.

In one embodiment of the invention, the determination of the supply availability comprises a determination as a function of a pump speed variable characterizing a pump speed of the pump device, in particular a value of the pump speed variable, and/or a swivel angle variable characterizing a swivel angle of the pump device comprising an axial piston pump comprising a variably settable sliding plate, in particular a value of the swivel angle variable. In particular, the pump speed variable can be the pump speed and/or a motor speed of a motor, in particular an internal combustion motor, in particular a diesel motor, and/or an electric motor, for driving, in particular for rotating, the pump device. Additionally or alternatively, variably settable may be referred to as adjustable or changeable. Further additionally or alternatively, variably settable can mean adjustable to at least three different values or levels and/or continuously adjustable. Further additionally or alternatively, the term “swash plate” can be used synonymously for the term “sliding plate”. Further additionally or alternatively, the determination of the supply availability may comprise a determination as a function of the size, in particular a value of the size, of the pump device. Further additionally or alternatively, the pump device may comprise a variable displacement pump, in particular the axial piston pump and/or a fixed displacement pump. In particular, the pump speed can be a pump speed, in particular a nominal speed, of the fixed displacement pump.

In a development of the invention, the increase comprises an increase in a, in particular the, pump speed, in particular a value of the pump speed, of the pump device and/or a, in particular the, swivel angle, in particular a value of the swivel angle, of the pump device comprising a, in particular the, axial piston pump comprising a, in particular the, variably settable sliding plate. This enables the insufficient supply to be compensated or even terminated. Additionally or alternatively, this makes it possible to keep the pump speed and/or the swivel angle low in the event of no insufficient supply. This makes it possible to reduce or optimize energy consumption, in particular fuel consumption. In particular, the increase can be an increase in a motor speed, in particular of the motor, in particular of an internal combustion motor, in particular of a diesel motor, and/or of an electric motor, for driving, in particular for rotating, the pump device. Additionally or alternatively, variably settable may be referred to as adjustable or changeable. Further additionally or alternatively, variably settable can mean adjustable to at least three different values or levels and/or continuously adjustable. Further additionally or alternatively, the term “swash plate” can be used synonymously for the term “sliding plate”. Further additionally or alternatively, the pump device may have a variable displacement pump, in particular the axial piston pump and/or a fixed displacement pump. In particular, the pump speed can be a pump speed, in particular a nominal speed, of the fixed displacement pump.

In a development of the invention, the reduction comprises a reduction by means of weighting of, in particular the and/or respective and/or current, supply requirements, in particular values of the supply requirements, of the drives, in particular with hydraulic liquid, for the total movement. In particular, the supply to the drive with the largest supply requirement is reduced and/or the supply to the drive with the smallest supply requirement is reduced to a lesser extent or is not reduced. This makes it possible to optimize the total movement particularly well in the event of an insufficient supply and/or to compensate for the insufficient supply particularly well. In other words: only one single movement/axis, e.g. which requires the most hydraulic liquid, in particular usually or typically the slewing gear, is reduced. Additionally or alternatively, the focus of the movements is shifted to the axes that require less hydraulic liquid. In particular, the weighting can be automatic and/or by means of weighting factors, especially in each case. In particular, the weighting factors can be dependent on the supply requirements, in particular reciprocal.

In a development of the invention, the method comprises the step of: outputting, in particular displaying, user-perceivable information, in particular a content of the information, about the, in particular current, insufficient supply, the, in particular current, checking and/or about the fact that the checking is not sufficient to end the insufficient supply, in particular during the checking or simultaneously or at the same time or together with the checking or step b). This enables the user to react accordingly. In particular, the output, especially the display, can be automatic and/or electrical and/or by means of an output device. Additionally or alternatively, warning information or a message or a warning signal, e.g. a yellow icon, can be output from, e.g., 90% (percent) utilization and a fault information or message or a fault signal, e.g., a red icon, can be output above 100%.

In a further embodiment of the invention, the distribution boom, the drives and/or the pump device are/is mobile, in particular movable. For such a distribution boom, such drives and/or such a pump device, the case of insufficient supply may be typical. In particular, the construction material and/or thick matter pump device can be mobile, in particular movable, in particular a truck-mounted construction material and/or thick matter pump, in particular a truck-mounted concrete pump.

The method according to the invention, in particular the automatic method, is for distributing construction material and/or thick matter by means of a, in particular the, construction material and/or thick matter pump device. The construction material and/or thick matter pump device has a distribution boom, in particular the distribution boom. The distribution boom has a conveying line, in particular a movable or adjustable conveying line, for conveying, in particular automatically, construction material and/or thick matter. The method comprises the method for controlling the total movement of the distribution boom as previously mentioned. The method comprises the step of: conveying, in particular automatically conveying, construction material and/or thick material during the control or simultaneously or concurrently or together with the control or step b), in particular by means of or through the conveying line. This enables distribution. In particular, the conveying line may comprise, in particular may be, a pipeline and/or an end hose.

The system according to the invention is for, in particular for the purpose of controlling a, in particular the, total movement of a, in particular the, distribution boom. The distribution boom has a plurality of, in particular the plurality of, boom arms. The boom arms can be moved by means of a plurality of hydraulic drives, in particular the plurality of hydraulic drives. The system has a monitoring device and a control device, in particular and the distribution boom, the drives and/or a, in particular the, hydraulic pump device. The monitoring device is designed to monitor, in particular is designed for the purpose of monitoring, whether at least one, in particular the at least one, drive of the drives for the total movement is insufficiently supplied by the hydraulic pump device for, in particular for the purpose of, supplying the drives with hydraulic liquid. In the event of insufficient supply, in particular in the case of insufficient supply, the control device is designed to control, in particular for the purpose of controlling, a non-proportional reduction of the supply of hydraulic liquid to the drives for, in particular for the purpose of, the non-proportional reduction of, in particular of the, movement speeds of the drives and/or an, in particular the, increase in the supply of hydraulic liquid to the drives by the pump device. The system can enable the same advantages as the aforementioned method(s). In particular, the system, in particular the monitoring device and/or the control device, can be designed to carry out, in particular automatically, one or more, in particular the aforementioned method(s). In particular, the monitoring device and/or the control device may comprise a computing unit, in particular a processor, and/or a memory unit. Further additionally or alternatively, the system may comprise the construction material and/or thick matter pump device.

Further advantages and aspects of the invention can be found in the claims and the description of exemplary embodiments of the invention, which are explained below with reference to the figures.

### BRIEF DESCRIPTION OF THE DRAWINGS

FIG. 1 shows schematically a system according to the invention and a method according to the invention for controlling a total movement of a distribution boom of the system and a method according to the invention for distributing construction material and/or thick matter by means of a construction material and/or thick matter pump device of the system having the distribution boom having the method for controlling the total movement of the distribution boom;

FIG. 2 shows schematically a block circuit diagram of the system of FIG. 1; and

FIG. 3 shows schematically a flow chart of the method of FIG. 1 carried out by means of the system of FIG. 1.

### DETAILED DESCRIPTION OF THE DRAWINGS

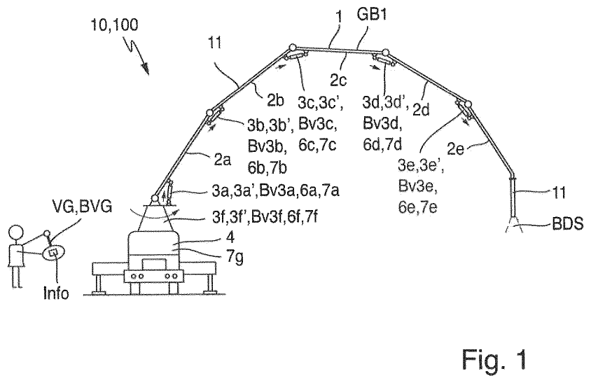

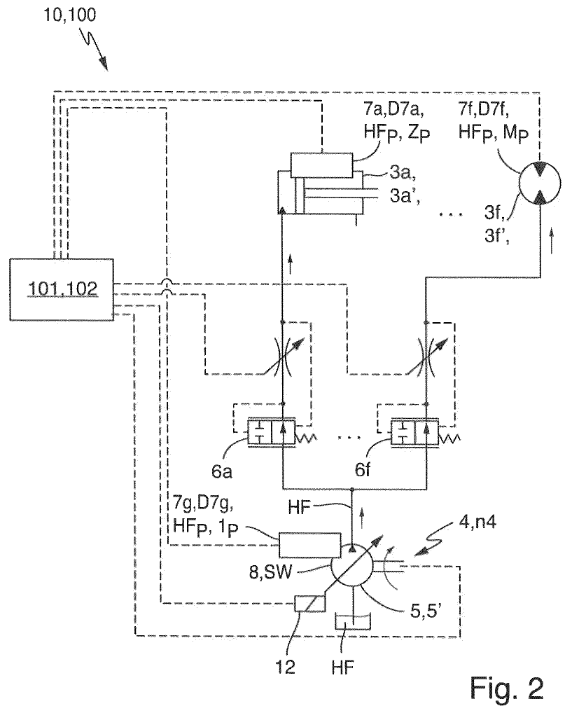

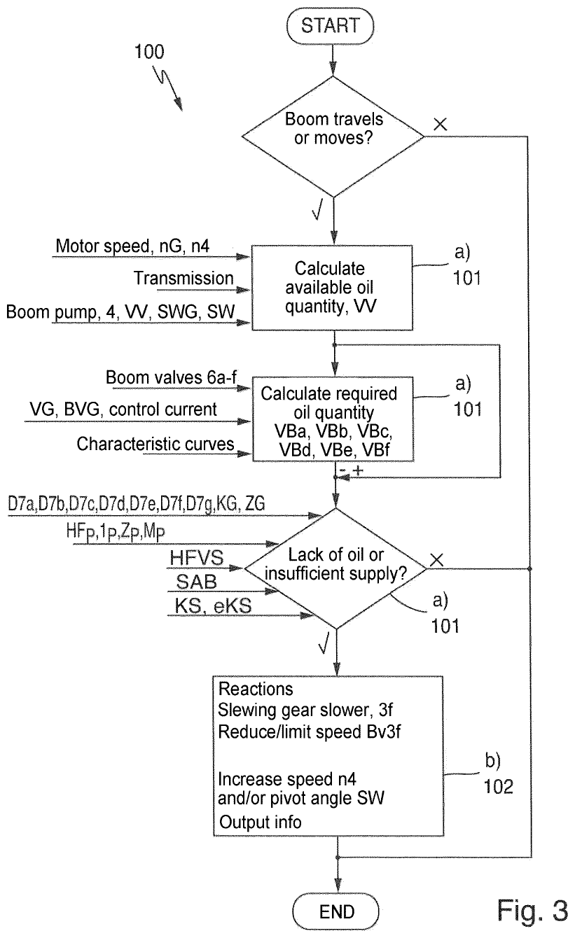

FIGS. 1 to 3 show a system 100 and a method for controlling a total movement GB1 of a distribution boom 1. The distribution boom 1 has a plurality of boom arms 2a, 2b, 2c, 2d, 2e. The boom arms 2a-e can be moved, in particular are moved, by means of a plurality of hydraulic drives 3a, 3b, 3c, 3d, 3e, 3f.

The system 100 has a monitoring device 101 and a control device 102, in particular and the distribution boom 1, the drives 3a-f, a hydraulic pump device 4 and/or a construction material and/or thick matter pump device 10. The monitoring device 101 is designed for monitoring, in particular monitors, whether at least one drive 3a-f of the drives 3a-f for the total movement GB1 is insufficiently supplied by the hydraulic pump device 4 for supplying the drives 3a-f with hydraulic liquid HF. In the event of insufficient supply, the control device 102 is designed to control, in particular controls, a non-proportional reduction of the supply of hydraulic liquid HF to the drives 3f for the non-proportional reduction of movement speeds Bv3f of the drives 3f and/or an increase in the supply of hydraulic liquid HF to the drives 3a-f by the pump device 4.

The method has the following steps: a) monitoring whether the at least one drive 3a-f of the drives 3a-f for the total movement GB1 is insufficiently supplied by the hydraulic pump device 4 for the supply of hydraulic liquid HF to the drives 3a-f, in particular by means of the monitoring device 101; b) in the event of insufficient supply, controlling the non-proportional reduction of the supply of hydraulic liquid HF to the drives 3f for the non-proportional reduction of movement speeds Bv3f of the drives 3f and/or the increase in the supply of hydraulic liquid HF to the drives 3a-f by the pump device 4, in particular by means of the control device 102.

Furthermore, FIG. 1 shows the method for distributing construction material and/or thick matter BDS by means of the construction material and/or thick matter pump device 10. The construction material and/or thick matter pump device 10 has the distribution boom 1. The distribution boom 1 has a conveying line 11 for conveying construction material and/or thick matter BDS. The method comprises the method for controlling the total movement GB1 of the distribution boom 1 as previously mentioned, in particular by means of the system 100. The method comprises the step of: conveying construction material and/or thick material BDS during the control, in particular by means of the system 100.

In the exemplary embodiment shown, the distribution boom 1 has five boom arms 2a-e. In alternative exemplary embodiments, the distribution boom can have at least three or more than five boom arms.

Furthermore, in the exemplary embodiment shown, the system 100 has six drives 3a-f. In alternative exemplary embodiments, the system may have at least four or more than six drives.

In detail, the pump device 4 is, in particular only, one, in particular single, common pump device 4′ for supplying the drives 3a-f with hydraulic liquid HF. In particular, the pump device 4 has only a single hydraulic pump 5.

Furthermore, at least one of the drives 3a-f, in the exemplary embodiment shown each of the drives 3a-f, has an electrically controllable hydraulic valve 6a, 6b, 6c, 6d, 6e, 6f. Controlling the reduction involves controlling the hydraulic valve 6a-f.

In addition, at least one of the drives 3a-e, 3f, in the exemplary embodiment shown each of the drives 3a-e, is a hydraulic cylinder 3a′, 3b′, 3c′, 3d′, 3e′ and/or, in the exemplary embodiment shown, the drive 3f is a hydraulic motor 3f.

Furthermore, the monitoring comprises: determining, in particular capturing, in particular and evaluating, data D7a, D7b, D7c, D7d, D7e, D7f, D7g of at least one sensor device 7a, 7b, 7c, 7d, 7e, 7f, 7g, in the exemplary embodiment shown at least seven sensor devices 7a-f, in particular of the system 100 and/or by means of the monitoring device 101. In particular, the insufficient supply is ascertained as a function of the data D7a, D7b, D7c, D7d, D7e, D7f, D7g, in particular by means of the monitoring device 101.

In detail, the data D7a-g comprise at least one control variable KG of at least one of the drives 3a-f and/or at least one status variable ZG of the pump device 4, at least one of the drives 3a-f and/or at least one of the boom arms 2a-e, in particular are such a variable. In particular, the data D7a-g comprise a control signal KS, in particular an electrical control current eKS, a hydraulic liquid volume flow HFVS, a hydraulic liquid pressure HFp, in particular a boom pressure 1p, a cylinder pressure Zp and/or a motor pressure Mp, and/or a trailing distance SAB, in particular are such a variable.

In addition, the monitoring comprises: determining, in particular calculating, supply requirements VBa, VBb, VBc, VBd, VBe, VBf of the drives 3a-f for the total movement GB1, in particular by means of the monitoring device 101. Additionally or alternatively determining, in particular calculating, a supply availability VV by the pump device 4, in particular by means of the monitoring device 101. In particular determining the insufficient supply if the supply requirements VBa-f are greater than the supply availability VV, in particular by means of the monitoring device 101.

In detail, the determination of the supply requirements VBa-f is dependent on a specification VG, in particular a user specification BVG, for the total movement GB1.

Furthermore, the determination of the supply availability VV comprises a determination as a function of a pump speed variable nG characterizing a pump speed n4 of the pump device 4 and/or a swivel angle variable SWG characterizing a swivel angle SW of the pump device 4 having an axial piston pump 5′ having a variably settable sliding plate 8.

In addition, the increase involves increasing the pump speed n4 of the pump device 4 and/or the swivel angle SW of the pump device 4 comprising the axial piston pump 5′ comprising the variably settable sliding plate 8, in particular by means of the control device 102.

In the exemplary embodiment shown, the system 100 has an actuator 12, in particular an electrically controllable or adjustable actuator 12. The actuator 12 is designed for variable adjustment of the swivel angle SW, and in particular adjusts it.

Furthermore, the reduction comprises a reduction by means of weighting of the supply requirements VBa-f of the drives 3a-f for the total movement GB1, in particular by means of the control device 102. In particular, the supply of the drive 3f with the largest supply requirement VBf is reduced and/or the supply of the drive 3a-e with the smallest supply requirement VBa-e, in the exemplary embodiment shown of the drives 3a-e with the smallest supply requirements VBa-e, is reduced to a lesser extent or is not reduced.

The method also comprises the step of outputting, in particular displaying, user-perceivable information about the insufficient supply, the control and/or about the fact that the control is not sufficient to end the insufficient supply.

Furthermore, the distribution boom 1, the drives 3a-f and/or the pump device 4 are/is mobile, in particular movable.

In addition, the monitoring device 101, the control device 102, the drives 3a-f, in particular by means of the hydraulic valve 6a-f, the pump device 4, in particular by means of the actuator 12, and/or the at least one sensor device 7a-g, in particular in each case, have an active connection, in particular a signal connection, in particular an electrical signal connection.

As the exemplary embodiments shown and explained above make clear, the invention provides an advantageous method and an advantageous system, in particular in each case, for controlling a total movement of a distribution boom having, in particular in each case, improved characteristics, and an advantageous method for distributing construction material and/or thick matter by means of a construction material and/or thick matter pump device having an adjustable distribution boom having such a method for controlling the total movement of the distribution boom.

1.-15. (canceled)

16. A method for controlling a total movement of a distribution boom, wherein the distribution boom has a plurality of boom arms movable via a plurality of hydraulic drives, the method comprising the steps of:
a) monitoring whether at least one drive of the plurality of drives for the total movement is insufficiently supplied by a hydraulic pump device for supplying the plurality of drives with hydraulic liquid; and
b) in an event of an insufficient supply, controlling a non-proportional reduction in the supply of the hydraulic liquid to the drives for non-proportional reduction of movement speeds of the drives and/or an increase in the supply of hydraulic liquid to the drives by the pump device.

17. The method as claimed in claim 16, wherein
the pump device is a common pump device for supplying the drives with hydraulic liquid.

18. The method as claimed in claim 16, wherein
at least one of the drives comprises an electrically controllable hydraulic valve, and
the control of the reduction comprises a control of the hydraulic valve.

19. The method as claimed in claim 16, wherein
at least one of the drives is a hydraulic cylinder and/or a hydraulic motor.

20. The method as claimed in claim 16, wherein the monitoring comprises:
determining and evaluating data from at least one sensor device, and
ascertaining insufficient supply depending on the data.

21. The method as claimed in claim 20, wherein
the data comprise at least one control variable of at least one of the drives and/or at least one status variable of: the pump device, at least one of the drives and/or at least one of the boom arms.

22. The method as claimed in claim 21, wherein the data comprises a control signal, an electrical control current, a hydraulic liquid volume flow, a hydraulic liquid pressure, a boom pressure, a cylinder pressure and/or a motor pressure, and/or a trailing distance.

23. The method as claimed in claim 16, wherein the monitoring comprises:
determining supply requirements of the drives for the total movement, and/or
determining a supply availability by the pump device, and
ascertaining the insufficient supply when the supply requirements are greater than the supply availability.

24. The method as claimed in claim 23, wherein
the determination of the supply requirements comprises a determination as a function of a specification for the total movement.

25. The method as claimed in claim 24, wherein
the determination of the supply availability comprises a determination as a function of a pump speed variable characterizing a pump speed of the pump device and/or a swivel angle variable characterizing a swivel angle of the pump device comprising an axial piston pump comprising a variably settable sliding plate.

26. The method as claimed in claim 16, wherein
the increase comprises an increase in a pump speed of the pump device and/or a swivel angle of the pump device comprising an axial piston pump comprising a variably settable sliding plate.

27. The method as claimed in claim 16, wherein
the reduction comprises a reduction by way of weighting of supply requirements of the drives for the total movement, including reducing the supply of the drive with the largest supply requirement and/or reducing to a lesser extent or not reducing the supply of the drive with the smallest supply requirement.

28. The method as claimed in claim 16, further comprising:
outputting user-perceptible information about the insufficient supply, the control and/or about the fact that the control is not sufficient to end the insufficient supply.

29. The method as claimed in claim 16, wherein the distribution boom, the drives and/or the pump device are/is mobile.

30. A method for distributing construction material and/or thick matter via a construction material and/or thick matter pump device, wherein the construction material and/or thick matter pump device has a distribution boom, wherein the distribution boom has a conveying line for conveying construction material and/or thick matter, the method comprising:
the method for controlling a total movement of the distribution boom as claimed in claim 16; and
conveying construction material and/or thick matter during the control.

31. A system for controlling a total movement of a distribution boom, wherein the distribution boom comprises a plurality of boom arms, wherein the boom arms are movable via a plurality of hydraulic drives, the system comprising:
a monitoring device, wherein the monitoring device is configured to monitor whether at least one drive of the drives for the total movement is insufficiently supplied by a hydraulic pump device for supplying the drives with hydraulic liquid; and
a control device, wherein the control device is configured, in an event of insufficient supply, to control a non-proportional reduction in the supply of hydraulic liquid to the drives for the non-proportional reduction of movement speeds of the drives and/or an increase in the supply of hydraulic liquid to the drives by the pump device.
